(19) United States
(12) Patent Application Publication
(10) Pub. No.: US 2017/0096209 A1
(43) Pub. Date: Apr. 6, 2017

(54) "VESTAPLAN" GLIDING HELISTAT

(71) Applicant: Nikolai Borisowich SHULGIN, Krasnoyarsk (RU)

(72) Inventor: Nikolai Borisowich SHULGIN, Krasnoyarsk (RU)

(21) Appl. No.: 15/316,902

(22) PCT Filed: Mar. 30, 2015
(86) PCT No.: PCT/RU2015/000200

§ 371 Date: Dec. 7, 2016

(30) Foreign Application Priority Data
Jun. 18, 2014 (RU) 2014124602

(51) Int. Cl. B64B 1/66; B64B 1/08

(52) U.S. Cl. CPC B64B 1/66; B64B 1/08

(57) ABSTRACT

The invention relates to the field of aviation, and specifically to aircraft structures. The present hybrid aircraft comprises an aerostat with a rigid frame, ballonets with helium, a suspension system, and a bearing platform with a cargo/passenger cabin. The cabin includes controls, engines, electrical equipment and measurement devices. The aerostat is composed of two envelopes connected by a cylindrical hinge and provided with affixing elements, controlling the rotation of which allows for changing and securing the aerostat in the form of a wing or in the form of an A-shape with an opened fairing. The suspension system includes rigid and flexible connections and is capable of being transformed and secured. The stationing and securing of the device in a stable position can be carried out on a sloped solid ground surface, on a water surface, or on a vertical structure.

### CROSS-REFERENCE TO RELATED APPLICATIONS

The present patent application is a national stage application of the PCT application PCT/RU2015/000200 filed Mar. 30, 2015 which claims priority to Russian patent application RU 2014124602 filed Jun. 18, 2014. all of which are incorporated herein by reference.

### FIELD OF INVENTION

The invention relates to the field of aviation.

### BACKGROUND

Known hybrid aircrafts described in many patents and publications. They are characterized by different combinations of attributes helicopter, balloon, aircraft and glider. The aircrafts in Filimanov's Russian patent RU2059530, as well as other Russian patents—Patent RU 2066661, RU 2074101, and RU 2104903 have inherent features of helicopters and aerostats. The device in RU 2104214 combines inherent features of aerostat and glider. The aerial vehicle in RU 2104214 represents an inherent feature of aerostat and adjustable features of helicopter and airplane. Drawing in RU 2256584 describes the structure with the adjustable features of aerostat and airplane. All of them, except device in RU 2104903, are intended for creating lifting three from 1000 kg and more. They all have the same disadvantages:
Low speed and maneuverability during takeoff and landing;
Takeoff and landing are carried out at aerodromes equipped with special technical equipment with the help of maintenance staff;
Typically parking requires special equipment and dosed areas;

The aircraft in RU 2160689 is selected as a prototype because it coincides with the claimed device in terms of the maximum number of attributes.

### SUMMARY

The subject of claim is a hybrid aircraft which has the adjustable features of helicopter, aerostat, airplane and glider (hereinafter referred to as “vestaplan”) and can be stationed, on a water surface, solid surfaces and structures with different angles of slopes.

The claimed device combines the adjustable characteristics of the helicopter, aerostat, aircraft and glider through the use of its components: the transformable aerostat, adjustable semi-rigid suspension system and engines with propellers, in which direction of the thrust vector can be changed by 360° in the vertical plane. By controlling these means, geometry, static and dynamic properties of the claimed device can be changed. These changes implements the features of the mentioned aircrafts. At the same time the device has various stationing options based on adapting of aerostat, suspension system and engines which form its design to the following parking conditions:
on a solid, ground surface with a slope angle 30°,
on a vertical rigid structure with a slope angle 30° front the vertical axis;
on a water surface.

Adaptation is carried out for fixing the device in a stable condition for a long time without assistance.

The claimed, device solves the following problems of year-round operation of personal air vehicles in various climatic and atmospheric conditions:
parking on unprepared airfields in mountains, forests, in a field, in basins;
parking in urban areas: at parking, lots; at sandlots and lawns unavailable for cars; on roofs of stand-alone garages, roofs and walls of multi-storey buildings and structures;
take-off/landing and final approach/casting, off the above-mentioned stationing places without applying special technical equipment and without the help of maintenance staff;
active (with using engines), controllable movement and maneuvering in the air space;
passive (without using engines), controllable movement and maneuvering in the air space.

The vestaplan design comprises a transformable aerostat consisting of two identical rigid envelopes with buoyant gas. The envelopes have a rigid frame modeling straight cylinders; Cylinder base—it is half of the airfoil. On the outside the cylinder bases have balloons rounding flat cylinders' bases. The envelopes are connected between each other with by a cylindrical hinge, located on moving lines passing through a salient point of the semi-airfoil section and controllable lock located on the other side of the profile. If the lock is opened, the envelopes can freely rotate around the hinge line; at the same time above the gap which is formed between the envelopes fairing is opened. Connecting and closing the lock parts the envelopes are fixed in the position with the form of a straight cylinder with bases to form a complete airfoil section. In this case, the aerostat represents a cylindrical wing, the profile chord of which is greater than the profile height and cylinder height, while the profile height is less than the cylinder height. The front and rear wing ends have bumpers mounted which protect the envelopes from damage. From below, in the front and rear wing parts traverse beams are situated. Beams are mounted to the envelopes' frames. The beams have suspension slings attached to them with one end which are intended for controlling envelopes' rotation angle. The other slings' ends are attached to controls in a cargo/passenger cabin.

From below the aerostat has the bearing platform mounted to on with a semi-rigid suspension system. The suspension system is composed of aerostat envelopes' control slings made from composite materials, rigid rotary racks and control slings of rotary racks. Lower ends of rotary racks are fixed hingedly to the upper horizontal beam of the platform vertical frame, while the upper ends of rotary racks have the hinges' spinning axis of the aerostat envelopes passing through them. The racks turn at the specified angle and are fixed by means of slings which are mounted to the rotary racks by one end and to the cargo-and-passenger cabin by the other end.

The bearing platform is made from composite materials and represents a horizontal lattice frame. On the middle line of horizontal lattice frame mounted a fixed vertical frame with three gaps. The two end gaps have engines with propellers, one in each gap. The engines can rotate and be fixed in the predetermined position so that directions of engine thrust vectors can be changed independently in the profile plane to the 180° angle to both sides from the zero position. Also, the bearing platform has the following components placed:
The cargo/passenger cabin is mounted in the middle opening and fixed. The cabin includes a pilot seat, cargo/passenger seat and controls of aerostat, rotary racks and engines, in addition to the pilot, the cabin can accommodate one passenger and/or cargo with limited total weight.
Insulated vessels playing the role of chassis or float which are fixed on the lower surface of the bearing platform.

Transforming the aerostat and suspension system, changing speed and direction of engines' thrust vector, the vestaplan is set the following: active and passive movement modes: vertical take-off, horizontal casting off, active straight flight, maneuvering by vector and height, gliding night, pancaking, wandering, vertical landing, horizontal approach.

For the vestaplan stationing on a solid horizontal surface with a 30° slope rotary stacks are mounted vertically and perpendicular to the horizontal frame of the hearing platform The flight height is reduced until the insulated vessels of the bearing platform come into contact with the base surface. After disconnecting the aerostat lock one Should turn the aerostat envelopes until envelopes' bumpers thrust with the base surface. Then envelopes should he fixed in this position by control slings and the bearing platform should be mounted with anchors bulging out of the base surface. At the same time, above the opening which is formed between the envelopes fairing is partially opened.

For the vestaplan stationing on a water surface rotary racks are fixed vertically and perpendicular to the bearing platform horizontal frame. The flight height is reduced until insulated vessels of the bearing platform are partially submersed into water. After disconnecting the aerostat lock one should turn the aerostat envelopes until they thrust with the bearing platform horizontal frame, at the same time envelops with ends and bumpers are submersed into water. Then envelopes should be fixed in this position by control slings. At the same time, above the gap which is formed between the envelopes fairing is completely opened.

For the vestaplan stationing on a vertical rigid structure with a 30° slope from the vertical axis rotary stacks are mounted vertically perpendicular to the horizontal frame of the bearing platform. The mooring hooks installed, beforehand on the front envelope bumper are secured to anchors bulging out of the base structure. Turning the front envelope, the platform is lowered until the bearing platform and base structure come into contact and is attached to other anchors bulging out of the base structure.

### BRIEF DESCRIPTION OF DRAWINGS

FIGS. 1, 2 demonstrate the profile and frontal planes of the vestaplan in the “initial” position:
aerostat is fixed in the form of a wing;
rotary racks are fixed vertically and perpendicular to the bearing platform horizontal frame;
engine thrust vectors are directed parallel to rolling axis, towards the leading edge.

FIG. 3 shows the gap fairing between the envelopes.

FIG. 4 shows horizontal plane of the vestaplan bearing platform horizontal frame with the pilot cabin bottom with slings channels, winches for slings controls and insulated vessels in the form of semi-spheres on the lower surface of the bearing platform.

FIG. 5 demonstrates profile plane of the vestaplan in flight with the offset of center of gravity.

FIG. 6 shows profile plane of the vestaplan stationed on a horizontal solid surface.

FIG. 7 demonstrates profile plane of the vestaplan stationed on a water surface.

FIG. 8 shows profile plane of the vestaplan stationed on a vertical wall with a lug, anchors and landing on the horizontal surface.

### DETAILED DESCRIPTION OF THE PREFERRED EMBODIMENTS

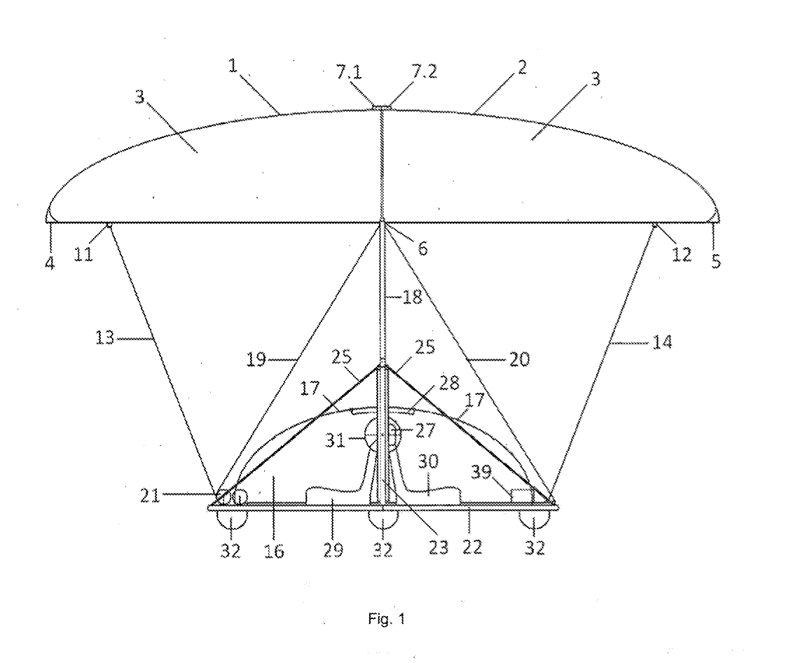

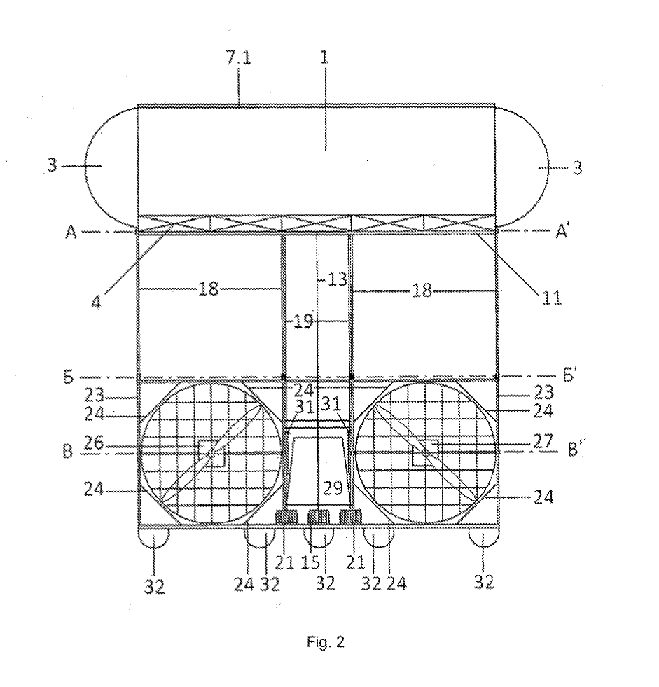

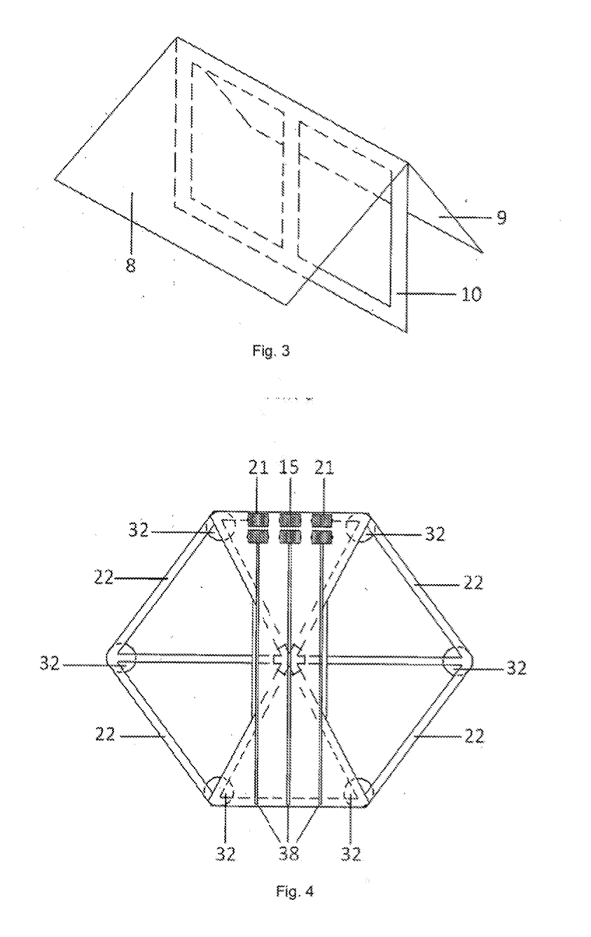

The transformable aerostat consists of front 1 and rear 2 envelopes (see FIG. 1, 2). The envelopes have rigid frames made from composite materials and covered with parachute fabric, and ballonets with helium are located inside. The frames model the envelopes as straight cylinders bases of which have the form of the first and second quadrants of ellipse which is prolate in horizontal direction and rounded at ends. On the outside on the cylinder bases there are containers filled with helium and rounding off the flat cylinders' bases to semi-round form. The ends have front 4 and rear 5 bumpers in the form of frames made of aluminum alloy. Bumpers are rigidly attached to the frame. The envelopes are connected by cylinder hinge 6 with axis on line AA′ and electromechanical controllable lock 7 on the other side of the envelopes' which consists of the front 7.1 and rear 7.2 pans, Lock control is performed remotely similar to car door lock control. If the lock is open, envelopes can rotate around the hinge axis 6 with the fairing opening above the gap which is formed between the envelopes. (see FIG. 3). The fairing consists of two identical parachute fabric stripes 8 and 9 each of which is attached by one side to the appropriate envelope and by the other side it is attached to the upper end of the rigid frame 10 made from carbon fiber. The frame 10 lower end is fixed hingedly on the hinge 6 axis. If the envelopes are tightly pressed against each other, the fairing is pressed between them in a folded position. With lock closed, the envelopes are fixed in the form of a straight cylinder with bases forming semi-ellipses with rounded front and rear ends which are protected with front and rear bumpers 4 and 5 and containers 3 on the right and on the left. In this case the aerostat represents a cylindrical wing having profile chord (wing length) greater than profile height (wing thickness) and cylinder height (wing width), and profile height is less than cylinder height. Front and rear wing parts on envelopes' frames, transverse beams 11 and 12 are located which have front 13 and rear 14 slings fixed to them with one end, which are designed for the turn of the wing or its envelopes' parts around the hinge 6 axis. Slings 13 and 14 other ends are attached to controls 15 in the cargo-and-passenger cabin 16 with fairing 17.

From below the aerostat has the bearing platform hanging on the semi-rigid suspension system. Suspension system is composed of: slings of wing 13 and 14 control; rotary racks 18; slings of rotary racks 19 and 20 control. Lower ends of rotary racks are attached with hinges, axes of which are located on line bb′, are mounted to the upper horizontal beam of the bearing platform vertical frame, and hinge 6 axis is passing through the racks' upper ends. The racks are turned at the specified angle and are fixed by front 19 and rear 20 slings which are attached with one end to the rotary racks' upper ends and with the other ends are attached to controls 21 in cabin 16.

The bearing platform is formed by the horizontal lattice frame 22 (see FIG. 4) which has a fixed vertical 23 having 3 gaps. The bearing platform rigidity is ensured by bracing cables 24 and 25. In the middle gap of the vertical frame there is as cargo-and-passenger cabin 16, two end gaps have paramotors 26 and 27 with propellers, diaphragm carburetors and electric starters. The paramotors are installed in bearings, on spinning axes which are located on line BB′. They can rotate around these axes and be fixed in the predetermined position so that their thrust vectors directions can be changed independently from each other in the profile plane by 360°, from −180° to +180°. Zero position is the position when rotation plane of propellers coincides with vertical frame 23 plane, and thrust vectors are directed towards the front part of the vestaplan.

Cargo-and-passenger cabin 16 has flat transparent side frames from transparent plastic and fairing from transparent plastic which opens upwards. The inner side of the cabin roof has dashboard 28. The cabin bottom (see FIG. 4) has the pilot seat 29, cargo-and-passenger seat 30, aerostat controls 15 and rotary racks' controls 21 and engines' turn controls 31. Controls 15 and 21 are winches, rotating which can change length and respectively change the envelopes rotation angle or rotary racks rotation angle. Besides, the front slings are attached to the front winches, and rear slings are attached to rear winches through slings' channels 38. Engines turn controls 31 represent steering wheels with gear case and catch lock located on middle gap frame of the vertical frame 23 and connected to spinning axes of engines' 26 and 27 housings. Electrical devices of vestaplan are powered by electrical battery. The cabin can accommodate one pilot, one passenger and/or cargo with limited total weight.

Insulated vessels 32 made from firm plastic and filled with air are fixed on the lower surface of horizontal frame 22. During stationing on a solid surface they serve as chassis, and during stationing on water they play the role of float.

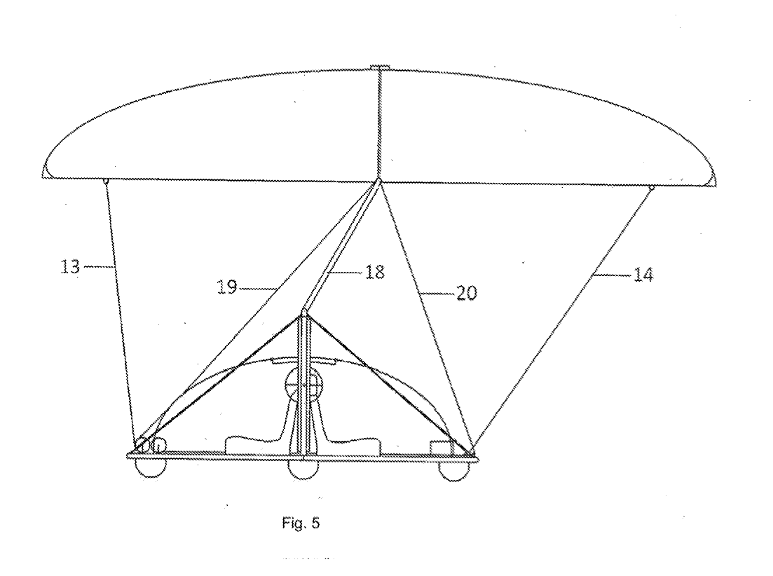

Transforming the aerostat and suspension system, changing speed and direction of engines' thrust vector, the vestaplan is set the following active (with non-zero engines' thrust vector) and passive movement modes; vertical take-off, horizontal casting off, active straight flight, maneuvering by vector and height, gliding flight, pancaking, wandering, vertical landing, horizontal approach. FIG. 5 demonstrates the profile plane of vestaplan in the mode of straight active flight with gravity center offset towards the leading edge for torque compensation resulting from approach air flow drag.

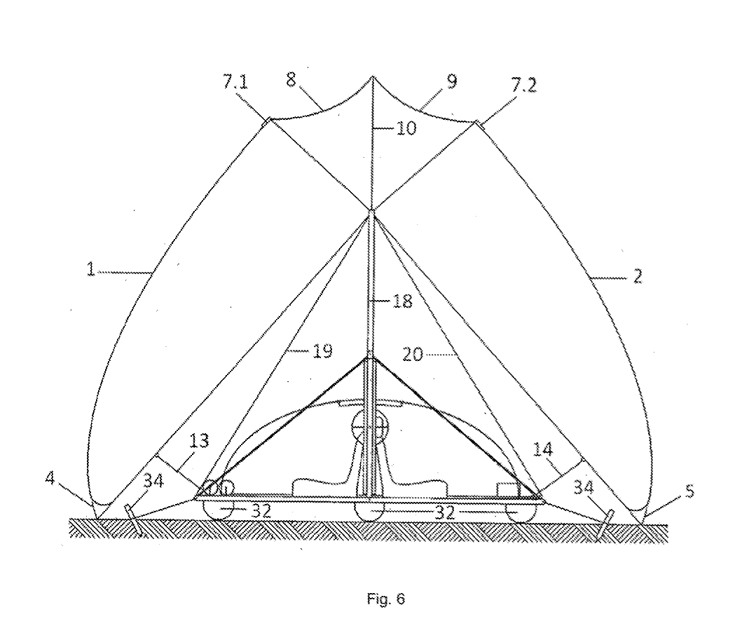

For the vestaplan stationing on a solid surface (see FIG. 6) rotary stacks 18 are mounted vertically and perpendicular to the horizontal frame of the platform. The flight height is reduced until insulated vessels 32 come into contact with the base surface, aerostat lock 7 is disconnected, aerostat envelopes are rotated downwards until bumpers 4 and 5 thrust with the base surface and slings 13 and 14, and envelopes are mounted in this position. Then the bearing platform is attached to anchors 34 by ropes 33. At the same time, above the gap which is formed between the envelopes fairing is partially opened which is created by elements 8, 9 and 10.

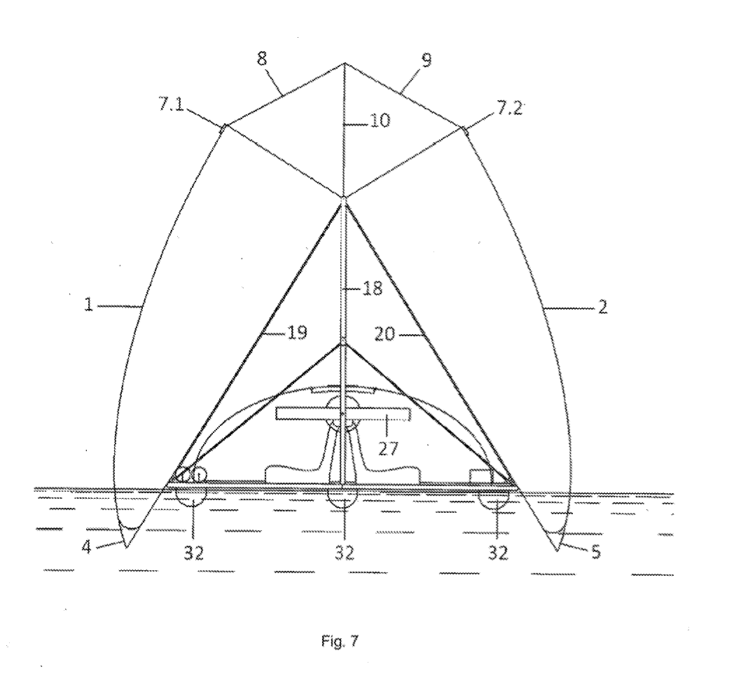

For the vestaplan stationing on a water surface (see FIG. 7) rotary stacks 18 are mounted vertically and perpendicular to the horizontal frame of the bearing platform. The flight height is reduced until insulated vessels 32 are partially submersed into water, aerostat lock 7 is disconnected, one should turn the aerostat envelopes until they thrust with the horizontal frame 22 and submerse envelopes' ends and bumpers 4 and 5 into water. Then envelopes should be fixed in this position by slings 13, 14. At the same time, above the gap which is formed between the envelopes fairing is completely opened which is created by elements 8, 9 and 10.

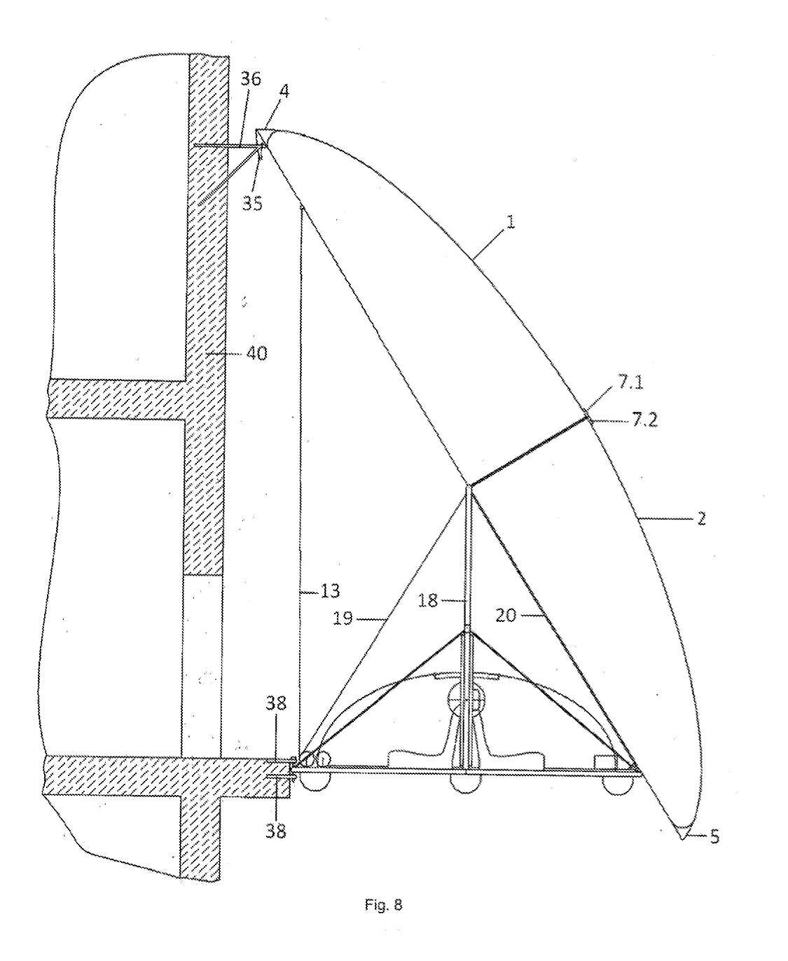

For the vestaplan stationing on a vertical wall 40 with a lug 41 (see FIG. 8) rotary racks 18 are fixed vertically and perpendicular to the bearing platform horizontal frame. The mooring hooks 35 installed beforehand on bumper 4 are secured to horizontal rods on brackets 36 and by turning the front envelope one should lower the platform until it thrusts with the lug—where the horizontal surface of the building begins, and then one should attach it to anchors 37 by a vertical rod. Such anchors and lug can be mounted on a blind wall of a multi-storey building, for example on a fire wall for approach directly to a job location or place of residence.

What is claimed is:

1.-4. (canceled)

5. A hybrid aircraft, comprising: an aerostat with a rigid frame, ballonets with helium, a suspension system, a bearing platform with a cargo/passenger cabin, controls, engines, an electrical equipment and measurement devices stationed at aerodromes with a help of maintenance staff; the aircraft differs in that the aerostat is composed of two envelopes connected by a cylindrical hinge and provided with affixing elements, controlling rotation of which allows changing and securing the aerostat in a form of a wing with an airfoil section or in a form of a A-shape with an opened fairing; wherein a suspension system includes rigid and flexible connections and is capable of being transformed and secured; and the engines are able to set a direction of thrust vectors from −180° to +180° in relation to a rolling axis of the platform; and a stationing and the securing of the device in a stable position is carried out by a pilot on different surfaces and structures without any maintenance staff.

6. A stationing of the device according to claim 5, wherein the stationing is performed on various surfaces of water, earth or structures.

3. The stationing of the device according to claim 5, wherein the stationing is on the water surface is characterized by the bearing platform touching the water surface, and the aerostat envelopes are turned, downward until a portion thereof is submerged in water.

4. The stationing of the device according to claim 2, wherein the stationing is on surfaces of earth or structure with slope 0°-45° is characterized by the bearing platform touching a base surface and being secured to reinstalled anchors, bulging out of the base surface, and the aerostat envelopes are turned downward until they come into contact with the sloped surface.

5. The stationing of the device according to claim 2, wherein the stationing is on surfaces of earth or structure with slope 45°-90° is characterized by mooring, hooks additionally installed on an end of the envelope, Which is a front envelope, and secured to anchors bulging out from a base structure at a level of the aerostat while the bearing platform touches the base structure and rigidly fixed to other anchors bulging out from the base structure at a level of the platform.
